(19) United States
(12) Patent Application Publication
(10) Pub. No.: US 2007/0296236 A1
(43) Pub. Date: Dec. 27, 2007

(54) Manually lockable module box for motor vehicles

(75) Inventors: Wolfgang Sitzler, Wuppertal (DE); Hartmut Bohlke, Wuppertal (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: BOS GmbH & Co., KG, Ostfildern (DE)

(21) Appl. No.: 11/809,965

(22) Filed: Jun. 4, 2007

(30) Foreign Application Priority Data
Jun. 23, 2006 (DE) 102006029311.8

(51) Int. Cl. B60R 11/00; B60N 3/12

(52) U.S. Cl. 296/37.8; 296/37.14; 296/37.15; 296/37.16

(57) ABSTRACT

A motor vehicle having a module box that is securable against theft. For this purpose, a manually actuatable lock is provided. The lock can be contained either in the module box or in the motor vehicle. Elements in the module box or the mounting arrangement that ensure that the opening mechanism of the module box and also the box's removal from the mounting arrangement are blocked are moved with the aid of a cylinder core of the lock.

### FIELD OF THE INVENTION

The present invention relates generally to motor vehicles, and more particularly, to storage compartments and modular containers for use in motor vehicles.

### BACKGROUND OF THE INVENTION

Motor vehicles are offered today with so-called through-load devices as special equipment. The through-load device includes an opening, which is disposed in a separating wall between the passenger compartment and the trunk or storage space. In this opening there is a mounting arrangement for receiving a container. The container, folded up in a stored or unused state, is designed to hold a ski bag. For usage, the ski bag is unfolded and skis are pushed into the ski bag from the trunk or storage space. The container that holds the ski bag can be detachably inserted into the mounting arrangement. After removal, the ski bag can easily be folded together and/or cleaned.

Instead of a ski-bag container, other containers can also be snapped into the mounting arrangement, such as, containers with cup holders, computer devices, and the like. It is further known to place module boxes at different positions in the vehicle, such as for convenient usage or urgent need.

Additionally, it is known to place containers in the trunk or storage space of the vehicle in order to better utilize the storage space. These containers also can be removed at any time when the trunk is open.

Unfortunately, practice has shown that the through-load opening in the separating wall between the passenger compartment and the storage space can be used as a means of illegal entry into the vehicle. After opening the trunk or hatch, the container can be removed relatively easily in order to create a passage to the interior.

The container can also be used as a place for safekeeping of valuables and naturally must then be secured, particularly against burglary.

### OBJECTS AND SUMMARY OF THE INVENTION

It is an object of the present invention to provide a vehicle having a module box that is secured, particularly so that it is well protected against theft or removal.

In a motor vehicle according to the invention, at least one mounting arrangement is provided which is designed to hold a container. The container can be removed from the mounting arrangement when desired.

The container is assembled from a body, and at least one cover is hinged on the body. To keep the body in the mounting arrangement, a latch is provided which interacts with a corresponding recess in the mounting arrangement. Furthermore, a locking mechanism is provided to keep the cover in the closed position.

To actuate the locking mechanism to open the cover, a manual actuation element is provided that is coupled to the locking mechanism. A manually actuatable lock, which can move back and forth between two positions, is associated with the actuation element, wherein in one position it blocks both the latch and also the locking mechanism from moving into the open position. Therefore, in the locked position of the lock, the container cannot be removed nor its cover opened.

Locking of the container in the mounting arrangement, such as in the case of a ski-bag box or a through-load device, causes the opening in the rear seatback structure to remain continuously and reliably locked. On the other hand, locking the cover guarantees secure safekeeping of objects in the container or the module box, which guarantees additional protection against theft.

Especially compact relationships are achieved if the lock is integrated into the actuation element. The lock can be in the form of a cylinder lock, with the cylinder housing being formed by the actuation element. The cylinder core or rotor is supported so that it can rotate in the cylinder housing. The cylinder housing can be mounted so that it is displaceable in the axial direction. Advantageously, the cylinder housing is displaceable in the axial direction relative to the rotor, which, on its side, is secured against axial displacement in the container.

The cylinder housing can be provided with a recess, which interacts with a cylinder fin. According to the position of the cylinder fin relative to the recess, the cylinder housing can move in the axial direction on the cylinder core or it is fixed.

For locking the latch, a locking bolt or member can be provided, which is coupled to the cylinder core. Rotating the cylinder core causes a translational movement of the locking bolt, which can interact, for example, with a corresponding recess on the latch in order to secure the locking latch against movement.

Another alternative involves using a locking bolt, which can move in the axial direction in the housing and which, with the aid of the cylinder core, can be brought into a position in which it is retracted relative to the outer contours of the container, or into a position in which it projects past the outer contours of the housing. In the projecting position, it engages in an opening in the mounting arrangement.

The mounting arrangement can be contained in a rear seatback of the vehicle and as already mentioned above, the container can involve a container for a ski bag. For this purpose, the body can have a tubular shape and, in addition to one cover, another cover can be provided, which is also hinged on the body.

The container can also involve a trunk container, which is held at a corresponding position in a corresponding niche in the trunk.

For locking the cover, the locking mechanism can comprise at least one moving hook, which interacts with a corresponding opening in the cover and which is biased by means of a spring into the engaged position with the opening. The hook can be coupled to a control button so that when the control button is pressed down, the hook can be moved into a position in which the engagement between the hook and the opening is lifted, in order to be able to open the cover.

According to another embodiment, the vehicle has at least one mounting arrangement. In the mounting arrangement, a container can be inserted, which again can be removed from the mounting arrangement at any time. The container has a body and a cover hinged on the body in order to create a space that can be closed. A locking mechanism is used to lock the cover in the closed position on the body.

The locking mechanism can be changed to an open position, in which the cover can be pivoted away from the body, by means of an actuation element that is actuated manually and which is coupled to the locking mechanism. The body contains a locking bolt, which is guided so that it can be displaced in the longitudinal direction in the body. The locking bolt can be moved out of a retracted position, in which it does not project past the body, into a pushed-forward position, in which it projects out of the body. In the projecting position, the locking bolt projects into a corresponding opening in the mounting arrangement when a module box is inserted. The locking bolt is moved with the aid of a lock that is actuated manually. The lock is associated with an actuation element.

As another variant, a vehicle is provided with a mounting arrangement. The mounting arrangement is used for holding a container, which can be selectively inserted into or removed from the mounting arrangement. To secure the container in the mounting arrangement, a latch is provided which is movably mounted on the container. The container is assembled from a body and at least one cover hinged on this body in order to create a hollow space that can be closed.

A locking mechanism is provided to hold the cover on the body in the locked position. An actuation element that is actuated manually is associated with the locking mechanism. The locking mechanism can be moved into a position in which the locking mechanism releases the cover with the aid of the actuation element.

A locking bolt, which is guided so that it can be displaced in the longitudinal direction in the mounting arrangement, is contained in the mounting arrangement. The locking bolt is used to secure the container in the mounting arrangement against theft. For this purpose, a lock contained in the mounting arrangement is provided that is coupled to the locking bolt. The lock can include a cylinder lock, with the actuation element forming the cylinder housing in which the cylinder core is held so that it can rotate. The cylinder housing can move axially and thus can also be used as an actuation element.

Other objects and advantages of the invention will become apparent upon reading the following detailed description and upon reference to the drawings, in which:

### BRIEF DESCRIPTION OF THE DRAWINGS

FIG. 1 is a broken-away perspective of a passenger vehicle having a modular storage container in accordance with the invention;

FIG. 2 is a cut-away perspective of the illustrated motor vehicle, as viewed from the rear trunk of the vehicle showing additional mounting arrangements for the subject storage container;

FIG. 3 is an enlarged front perspective of the illustrated container;

FIG. 4 is a side elevational view of the container shown in FIG. 3;

FIG. 5 is a fragmentary section of the illustrated module container illustrating the locking mechanism thereof;

FIG. 6 is a fragmentary section of an alternative embodiment of modular container; and

FIG. 7 is a fragmentary section of still another alternative embodiment of modular container according to the invention.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

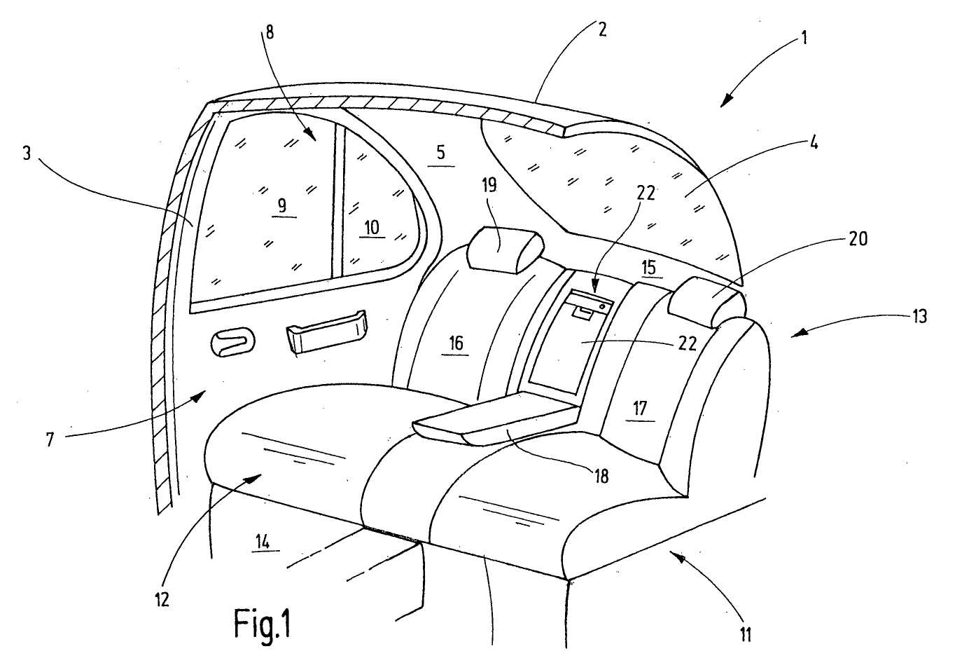

Referring now more particularly to FIG. 1 of the drawings, there is shown an illustrative passenger vehicle having a modular storage container in accordance with the invention. The figure illustrates a view towards the right inside of the rear area of the passenger vehicle, which is a mirror image of the (not-shown) left inside. The illustration is simplified. Thus, for example, internal structures of the car body, such as braces and attachment means, are not shown because their representation is not necessary for understanding the invention. Likewise, the illustration of the car body is a schematic.

The illustrated car-body section 1 has a roof 2 from which B-columns 3 extend downwardly on the sides to the floor of the vehicle. The roof 2 transitions into a rear window 4 at its rear edge. At each side, the rear window 4 ends at a C-column 5, which is located a distance from the B-column 3. The C-column 5 carries an appropriate inner lining that cannot be seen in detail.

A side rear door 7 is hinged to each B-column 3 in a known way between the B-column 3 and the C-column 5. Also in a conventional manner, the side door 7 has a window 8, which is divided into a section 9 with a pane that can be lowered, and a triangular section 10 with a rigid pane.

A rear seat bench 11, which includes a sitting surface 12 and a rear seatback 13, is positioned at the level of the right-side rear door 7. The sitting surface 12 is located on a base surface 14 of the floor assembly constructed in the foot space. Directly underneath the top edge of the rear seatback 13 there is a rear seat shelf 15, which extends to the bottom edge of the rear window 4.

The rear seatback 13 is divided into a right rear seatback section 16 and a left rear seatback section 17, which are spaced slightly apart from each other, as shown. In this intermediate space there is a rear seatback section 18, which is hinged at its bottom edge and which can be guided from a horizontal position as shown into a folded-up position in which it connects the two rear seatback sections 16, 17 to each other to create a third, extra seat. At the top edge of the rear seatback sections 16, 17 there are head supports 19, 20.

In the area normally covered by the middle rear seatback section 18, there is a mounting arrangement 21, in which a functional box 22 is detachably inserted by the user and is retained in a crash-safe way. The mounting arrangement 21 is fixed to the car body, for example, being housed in the structure for the right rear seatback section 16 as is typical today in motor vehicles.

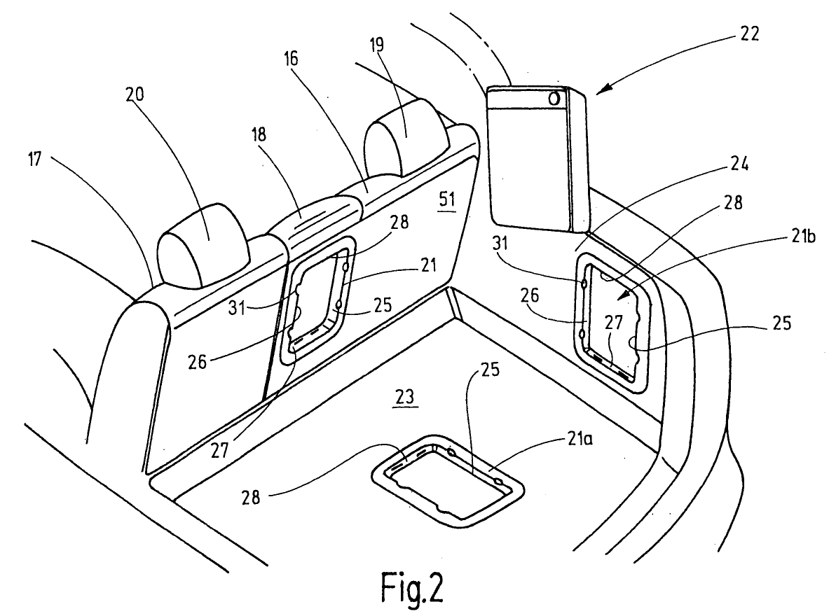

The mounting arrangement 21 for receiving and holding the functional box 22 is shown in FIG. 2 from the rear side. It has, for example, the shape of a short rectangular tube and is provided with structures to hold the module box detachably, which may be a ski bag container or the like. Other similar mounting arrangements 21a, 21b can be provided in the floor 23 of the trunk, or in a side wall 24, to mention only a few of the possible locations in the motor vehicle.

The mounting arrangement 21 is bounded by two parallel side walls 25, 26 and top and bottom walls 27, 28, which also are parallel to each other. The side walls 25, 26 have a parallelogram shape in their top view so that the top wall faces upwards to the vehicle compartment. The depth of the mounting arrangement 21 corresponds to the thickness of the function of module box. Further explanation of the mounting arrangement 21 is unnecessary to an understanding of the subject invention.

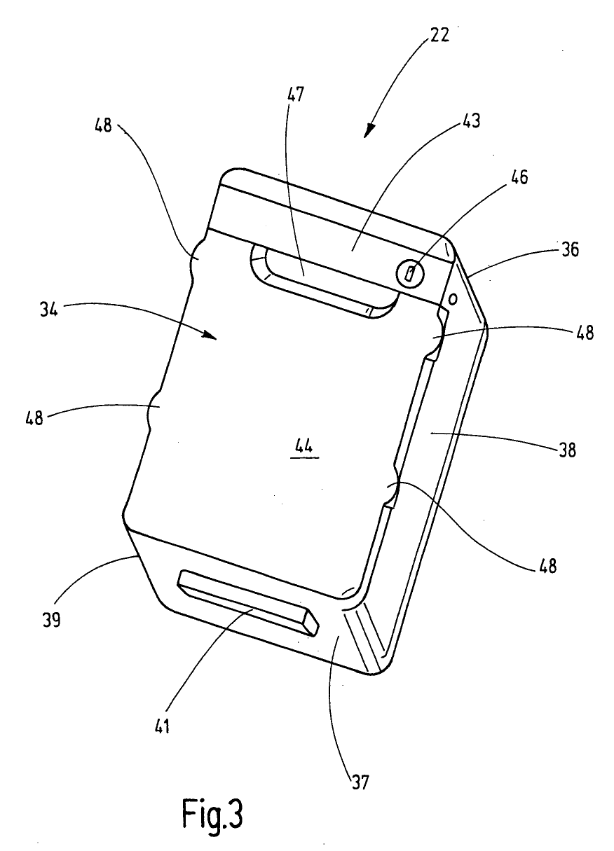

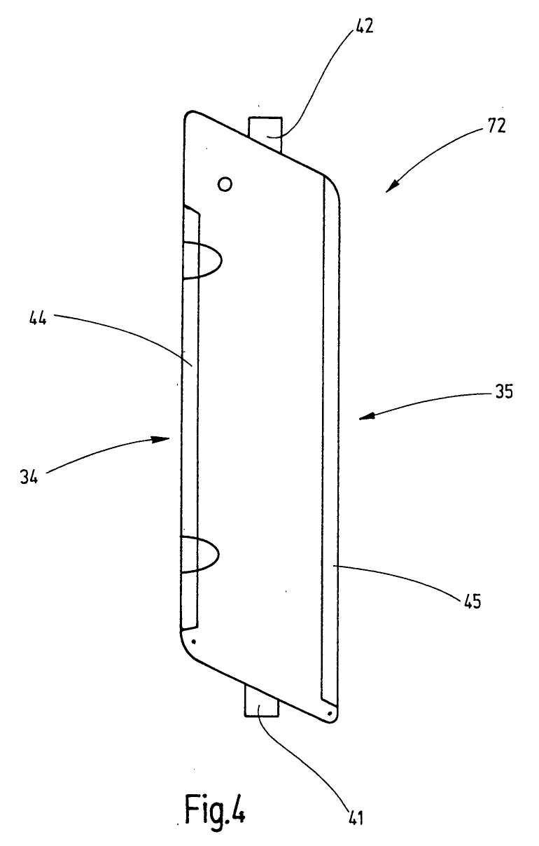

FIGS. 3 and 4 show a functional insert 22 in the shape of a module box, in whose interior there is a ski bag, for example, folded up. The module box 22 is a parallelepiped, which is bounded by a front side 34, a rear side 35, top and bottom narrow sides 36, 37, and two side narrow sides 38, 39. The two narrow sides 38, 39 are parallel to each other, as are the narrow sides 36, 37. The front side 34 also is parallel to the rear side 35. The narrow sides 36, 37, 38, 39 define the body of the module box 21. The lengths of the narrow sides 36, 37, 38, 39, and their angle relative to each other are dimensioned so that the insert 22 fits into the mounting arrangement 21 without additional means.

On the bottom side, and thus on the bottom narrow side 37, there is a bar 41, which interacts with a groove in the bottom wall 27 of the mounting arrangement 21. A catch latch 42, which can be retracted behind the contours defined by the top narrow side 36, movably projects into the top narrow side 36. For actuating the catch or locking latch 42 there is a handlebar 43, which is located in the front area 34 in the vicinity of the top edge. The handlebar 43 can pivot in a known way about a horizontal axis located adjacent the top edge. The mechanism used for transferring the movement of the handlebar 43 to the catch 42 may be any known type.

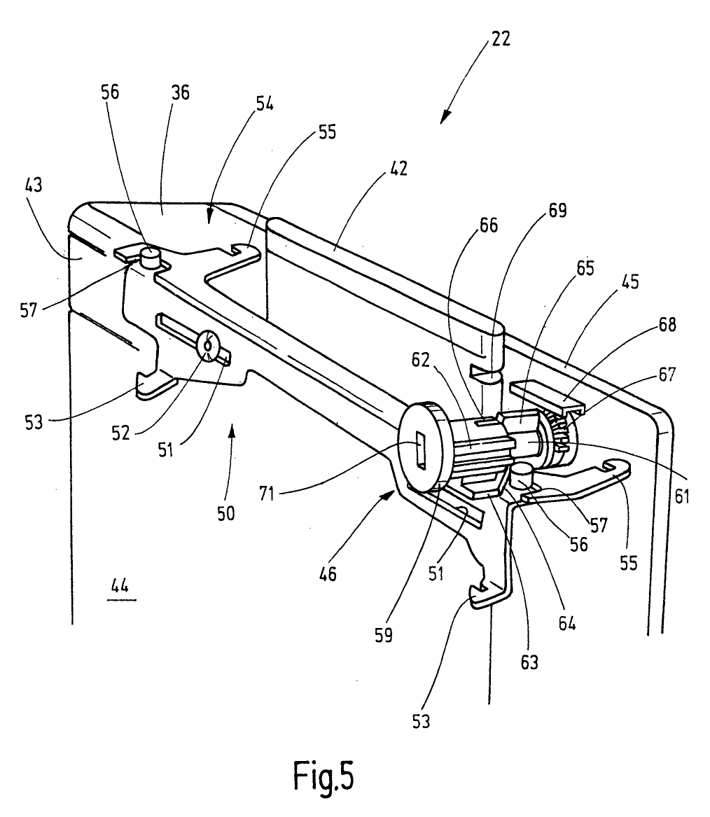

On the front side 34, a cover 44 is hinged for pivotal movement about a horizontal axis in the area of the bottom narrow side 37. The cover 44 extends from the bottom narrow side 37 up to the bottom edge of the handlebar 43. A rear cover 45 also is provided on the rear side 35 for pivotal movement about a bottom horizontal axis parallel to the pivot axis of the front cover. The two covers 44, 45 are held by associated latch mechanisms in the closed position. The unlocking of the cover 44 is performed by a push button 46 located in a bore of the handlebar 43. The locking of the cover 44 is discussed in more detail below in connection with reference to FIG. 5. The cover 44, the handlebar 43, and the push button 46 define an essentially flat plane, which is interrupted by a handle groove 47 in the front cover 44 located in the area of the bottom edge of the handlebar 43.

In order that the module box 22 freely and easily reaches the correct position when it is inserted, paraboloidal protrusions 48 are provided on the sides, which are complementary to the recesses in the mounting arrangement 21. The indentations 48 are partially located on the side of the front cover 44 and partially in the area of the long narrow sides 38, 39.

To insert and hold the module box 22 in the mounting arrangement 21, it is introduced into the mounting arrangement 21 with the bottom narrow side 37 first from the passenger compartment. In this way, the protrusions 48 adjacent to the bottom narrow side 37 prevent the module box 22 being pushed too deeply into the receptacle space 25. The mounting arrangement is designed so that the protrusions 48 move freely and easily into the indentation receiving recesses 31, when the edge of the narrow surface 37 is positioned upright on the bottom surface 30 of the receptacle space 25. The inserted module box 22 can be latched completely by pivoting it, with the bottom protrusions 48 acting in the associated recesses 31 like balls in ball sockets and defining a pivot axis.

The module box 22 also is securable against theft and undesired removal. The measures that are provided for this purpose according to the invention are explained below with reference to FIG. 5. The module box 22 is schematically depicted in the figure in order to better understand the essential features of the invention with portions omitted for simplification.

To hold the front cover 44 closed below the top narrow side 36 there is a front locking bolt or member 50 which is supported in the body at a right angle to the two side narrow sides 38, 39 and thus parallel to the top narrow side 36. The bolt 50 has two elongated slots 51, which are aligned with each other. Rivets 52, which are anchored in the body, each extend through a respective slot 51 for guiding movement of the bolt 50.

The bolt 50 in this case has two hooks 53 which project forwardly in the same direction and which interact with corresponding openings of the inside of the cover 54. The hooks 53 are spaced apart from each other, as shown, and are arranged in the vicinity of the respective slots 51.

A similar rear bolt 54, which is used to keep the rear cover 45 closed, is kinematically coupled to the front bolt 50 by appropriate means.

The rear bolt 54 also is provided with two hooks 55, which interact with corresponding openings in the rear cover 45. Both the front bolt 50 and also the rear bolt 54 are biased into the engaged position with the corresponding openings by appropriate biasing springs. The rear bolt 54 is coupled to the front bolt 50 by means of two upwardly extending, cylindrical pins 56, which project through rectangular recesses 57 of the rear bolt 54 and which are attached to the front bolt 50.

The relative position of the pins 56 to the recesses 57 and their size is determined by their function. Shifting the front bolt 50 in the direction opposite the opening direction of the hole of the hook 53 unlocks the front cover 44. The stroke that is necessary for this purpose is smaller than the play between the pins 56 and a limiting side wall 57. The rear bolt 54 thus initially remains in the locked position. Only when the stroke of the front bolt 50 exceeds the necessary stroke for unlocking the front cover 44 does the front bolt 50 entrain the rear bolt 54 with the aid of the pin 56, and moves this rear bolt so that the hooks 55 are freed from the engaged position with the rear cover 45. The movement of the front bolt 50, and also for a corresponding over-travel of the rear bolt 54, is caused by the push button 46.

As a safety device against theft, the push button 46 is constructed as a cylinder lock comprising a cylinder housing 59 and a cylinder core 61 that can rotate in the housing and move in the axial direction. The cylinder housing 59 is guided for axial movement so that it cannot rotate with the aid of ribs 62 on the outside and running parallel to each other in a corresponding structure in the body parallel to the longitudinal axis of the cylinder core 61 and thus perpendicular to the handlebar 43 or the surface of the cover 44. The structures for guiding the rib 62 are left out of the drawing in order not to negatively affect clarity and not to obscure the elements that are essential for understanding the invention.

On the bottom side of the cylinder housing 59 there is a connecting rod 63 with an inclined surface 64, which interacts with the adjacent pin 56. Through axial displacement of the cylinder housing 59 from the unused portion shown, the inclined surface 64 pushes the contacted pin 56 downwards to the right, as viewed in FIG. 5, and therefore brings the front bolt 54 into the position in which the engagement of the hooks 53 with the openings in the cover 44 is released. Even deeper pressing of the cylinder housing 59 then has the effect of also entraining the rear bolt 54, as described above.

The cylinder core or rotor 61 is rotatable and is mounted with an end projecting past the cylinder housing 59, as can be seen in the drawing. On the projecting part, the cylinder core carries a cylinder fin 65 in the shape of a narrow bracket extending upwardly for interaction with a slot 66 in the cylinder housing 59.

A pinion 67 is fixed to the cylinder core 61 on the open side beyond the cylinder fin 65. The pinion 67 meshes with a toothed rack 68 which is guided underneath the narrow side 36 so that it can move longitudinally in the body. The toothed rack 68 is used as a locking bolt and is arranged to secure the locking latch 42 against movement. For this purpose, the locking latch 42 contains a locking groove 69 facing in the direction towards the toothed rack 68. The toothed rack can move parallel to the cover 45 or top narrow side 36.

The foregoing arrangement functions as follows:

The position shown in FIG. 5 corresponds to the unlocked position, in which the cylinder fin 65 aligns with the slot 66. Therefore, the user can press the cylinder housing 59 like a push button into the module box 22 when desired, as described above, in order to move the bolt 50, or for deeper actuation, also the bolt 54, so that the two covers 44 and 45 can fold upwards.

Instead of actuating the cylinder housing 59, the user can also pivot the handlebar 43 upwardly about the axis lying next to the narrow side 36, whereby the locking latch 42 is moved against the effect of a biasing spring (not shown) downwardly into the module box 22 by means of a lever or the like, in order for them to be freed from corresponding, complimentary recesses in the mounting arrangement 21. The module box 22 can be removed without hindrance in this way.

If the user would like neither for the covers 44, 45 to be opened nor for the module box 22 to be removed as a whole, then he rotates the cylinder core 61, for example, from the shown position in the counterclockwise direction by, for example, one-quarter turn with the aid of a suitable key, which he inserts through an opening in the cylinder housing 59 into the cylinder core 61. Here, the cylinder fin 65 leaves its position aligned with the slot 66 and comes into a horizontal position. Simultaneously, the toothed rack 68 is pushed into the recess 69 of the catch 42. In this turned position of the cylinder core 61, an axial displacement of the cylinder housing 59 acting as a push button is no longer possible. The inner end of the cylinder housing 59 contacts the cylinder fin 65, which blocks the displacement. Because the inclined surface 64 of the connecting rod 63 is connected integrally with the cylinder housing 59, the pin 56 consequently can also no longer be pushed to the side in the sense of actuating the bolt 50.

The toothed rack 68 engaging in the recess 69 prevents the catch 42 from being moved downwardly when lifting the handlebar 43. Thus, the module box 22 is locked and cannot be removed from the mounting arrangement 21. The module box 22 itself is locked and is also locked in the vehicle, and thus is essentially protected from theft.

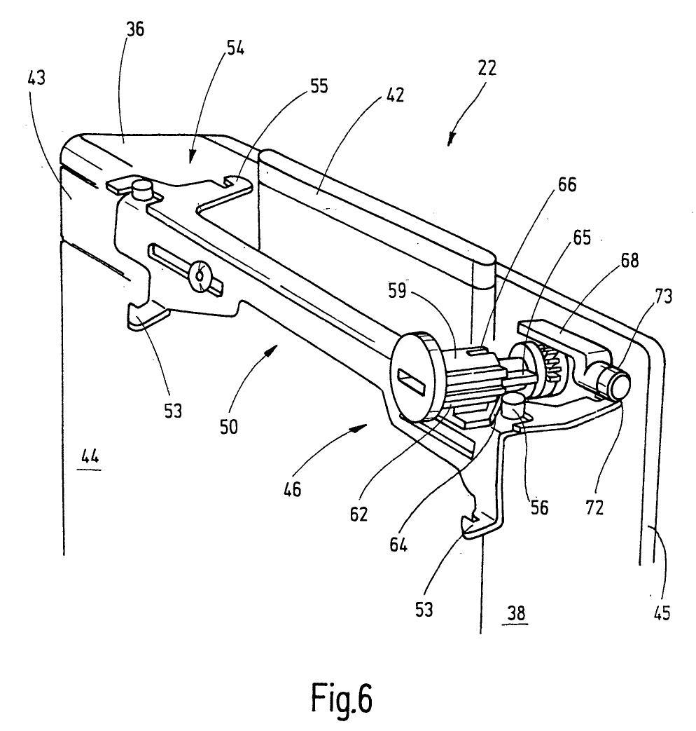

FIG. 6 shows a modified embodiment of a locking device for the locking of the module box 22 in the mounting arrangement 21. In the embodiment according to FIG. 5, locking of the module box 22 in the mounting arrangement 21 is implemented with the aid of locking the latch 42. In the embodiment according to FIG. 6, the toothed racks 68 on the end facing the narrow side 38 carry a pin 72. The pin 72 can be moved through an opening 73, which is contained in the narrow side 38. In a pushed-forward condition, the pin 72 projects into a corresponding opening in the mounting arrangement 21.

FIG. 6 shows the blocked position. In the illustrated position, the pin 72 is pushed forward. Simultaneously, the cylinder fin 65 is in a position in front of the end of the cylinder housing 49 in which it is no longer aligned with the slot 66. Therefore, it is impossible to press the cylinder housing 49 into the module box 22 in order to actuate the bolt or bolts 50 or 54 via the pin 56. On the other hand, it is also impossible to remove the module box by lifting the flap 43 and moving the latch 42. Even if the latch 42 is pushed back into the module box 22, in order to cancel as much as possible the locking position between the mounting arrangement 21 and the module box 22, the module box 22 nevertheless remains locked in the mounting arrangement 21. The forwardly pushed pin 72 is provided for this purpose which is inserted into a corresponding opening of the car body-fixed mounting arrangement 21.

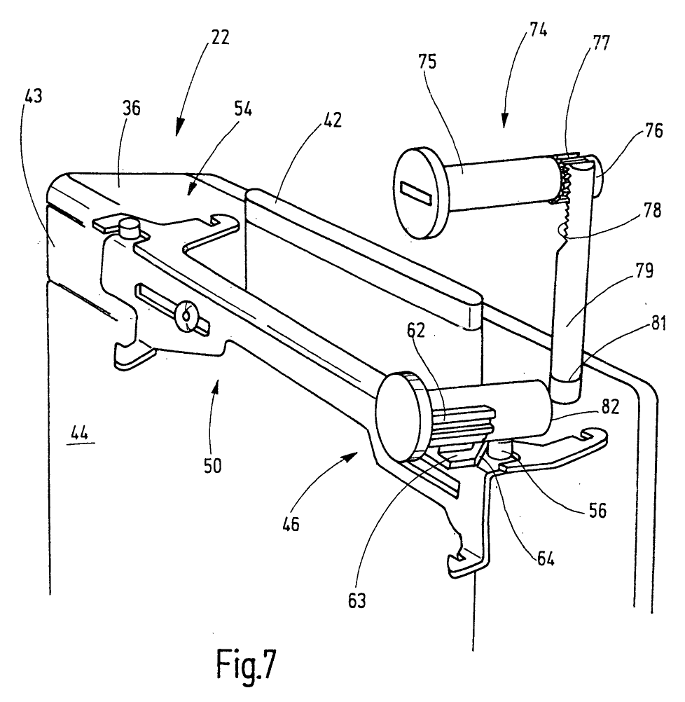

FIG. 7 illustrates an alternative embodiment in which a simplified cylinder lock 74 is integrated into the rear seatback 13. The cylinder lock includes a cylinder housing 75 with a cylinder core 76 that can rotate in the housing. The cylinder core carries a pinion 77 that interacts with a toothed rack 78. The toothed rack 78 transitions at one end into a locking bolt 79, which is guided in the mounting arrangement 21 so that it can move longitudinally.

In the top narrow side 36, the module box 22 has an opening 81, which is located in the extension of the control button 46. The control button 46 in FIG. 7 is in the form of a simple cylindrical pin with an actuation plate. For guiding and preventing rotation, it has ribs 62 as well as the connecting rod 63 with the inclined surface 64. On its inner end it forms a contact surface 82, which is outside of the open profile of the opening 81 in the non-actuated state.

In the unlocked position, with the aid of an appropriate key, the cylinder core 77 or rotor is turned into the opened position. In this position, the bolt 79 is retracted into the mounting arrangement and does not project into the opening 81.

The cover 45 can thus be opened by pressing the control button 46, as explained in detail above. In addition, the module box 22 can be removed at any time by lifting the flap 43 which causes the latch 42 to retract into the module box 22. The latch 42 moves free of the corresponding raised section in the mounting arrangement. The module box 22 then can be removed.

For locking, the cylinder core 76 is turned into the position shown in FIG. 7 with the aid of the key. In this way, the bolt 79 is pushed forward from the mounting arrangement 21. The bolt 79 is inserted into the opening 81 and moved until it is in front of the end surface 82 of the control button 46. The control button 46 can no longer be pressed.

Simultaneously, the engagement between the bolt 79 and the opening 81 prevents the removal of the module box 22 from the mounting arrangement. Even if the latch 42 is retracted with the aid of the flap 83, it is impossible to remove the module box 22 because the locking bolt 79 and the opening 81 are still engaged. The locking bolt blocks the movement necessary for removal in the direction perpendicular to the surface of the cover 44 because the axis of the locking bolt 79 is aligned parallel to the surface. It will be understood that the cylinder locks may have a conventional construction known to a person skilled in the art. It is sufficient that the lock have a cylinder housing that can be moved in an axial direction relative to the cylinder core in the unlocked position.

From the foregoing, it can be seen that a motor vehicle is provided that has a module box that is securable against theft. For this purpose, a lock is provided with a module box that can be actuated manually. The lock can be contained either in the module box or in the car body. With the aid of a cylinder core of the lock, elements in the module box or mounting arrangement are moved, which ensures that the opening mechanism of the module box and also the box's removal from the mounting arrangement are blocked.

1. A motor vehicle comprising:
at least one mounting arrangement (21),
a container (22) selectively insertable into the mounting arrangement (21) and removable from the mounting arrangement (21), said container (22) having a body (34-39) and at least one cover (44, 45) hinged on the body (34-39), a releasable latch (42) associated with the body (34-39) that is interactable with a recess in the mounting arrangement (21) for maintaining the body (34-39) locked in the mounting arrangement (21),
a releasable locking mechanism (50, 54) for locking the cover (44, 45) in a closed position on the body,
a manual actuation element (46) coupled to the locking mechanism (50, 54) for moving the locking mechanism (50, 54) to a released position for releasing the cover (44, 45), and
an actuatable lock (59, 61) associated with the actuation element (46) that is movable back and forth between two positions in response to manual actuation of said actuation element (46) wherein in one position the lock (59, 61) blocks both movement of the latch (42) and movement of the locking mechanism (50, 54) to the released position.

2. The motor vehicle of claim 1 in which said lock (59, 61) is an integrated part of the actuation element (46).

3. The motor vehicle of claim 1 in which said actuation element (46) includes a cylinder housing (59) within which a cylinder core (61) is rotatably mounted.

4. The motor vehicle of claim 3 in which said cylinder housing (59) is mounted for displaceable movement in an axial direction.

5. The motor vehicle of claim 3 in which said cylinder housing (59) is displaceable in an air axial direction relative to the cylinder core (61).

6. The motor vehicle of claim 3 in which said cylinder housing (59) has a recess (66) for interactive reception of a cylinder fin (65) on the cylinder core (61).

7. The motor vehicle of claim 1 including a locking member (68) mounted for displacement movement in the container (22).

8. The motor vehicle of claim 7 in which said locking member (68) is coupled with a rotatable cylinder core (61) such that the locking member (68) is displaced in an axial direction in response to rotatable movement of the cylinder core (61).

9. The motor vehicle of claim 8 in which said locking member (68) interacts with said latch (42) for locking the latch (42) in position for maintaining the body in the mounting arrangement.

10. The motor vehicle of claim 1 in which said mounting arrangement (21) is in a rear seatback (13) of the vehicle.

11. The motor vehicle of claim 10 in which said mounting arrangement (21) forms a through-load opening in the rear seatback (13).

12. The motor vehicle of claim 1 in which said mounting arrangement (21) is disposed in a storage or trunk space of the vehicle.

13. The motor vehicle of claim 1 in which said body (34-39) has a tubular shape with covers (44, 45) on opposite ends.

14. The motor vehicle of claim 1 in which said container (22) is a ski-bag container.

15. The motor vehicle of claim 1 in which said container (22) is a trunk container.

16. The motor vehicle of claim 1 in which said locking mechanism (50, 54) comprises at least one movable hook (53, 55) that interacts with an opening in a cover (44, 45) of the body (34-39) and which is resiliently biased into a position of engagement with the opening.

17. The motor vehicle of claim 16 in which said actuation element (46) includes an actuatable control bottom, and said hook (53, 55) is moveable to a position in which engagement of the hook (53, 55) and opening is released in response to actuation of the control bottom for allowing opening of the cover (44, 45).

18. The motor vehicle of claim 1 in which said body (34, 39) has an opening (73) for receiving and holding said locking member (68).

19. A motor vehicle comprising:
at least one mounting arrangement (21),
a container (22) selectively insertable into the mounting arrangement (21) and removable from the mounting arrangement (21), said container (22) having a body (34-39) and at least one cover (44, 45) hinged on the body (34-39), a releasable latch (42) associated with the body (34-39) that is interactable with a recess in the mounting arrangement (21) for maintaining the body (34-39) locked in the mounting arrangement (21),
a releasable locking mechanism (50, 54) for locking the cover (44, 45) in a closed position on the body,
a manual actuation element (46) coupled to the locking mechanism (50, 54) for moving the locking mechanism (50, 54) to a released position for releasing the cover (44, 45),
a locking member (68) supported in said body (34-39) for longitudinal displaceable movement into a position projecting from the body for engagement with an opening in the mounting arrangement (21) and
said actuation element (46) including a lock (59, 61) operable for blocking movement of the locking mechanism (50, 54) to a cover releasing position.

20. The motor vehicle of claim 19 in which said lock (59, 61) is an integrated part of the actuation element (46).

21. The motor vehicle of claim 19 in which said actuation element (46) includes a cylinder housing (59) within which a cylinder core (61) is rotatably mounted.

22. The motor vehicle of claim 21 in which said cylinder housing (59) is mounted for displaceable movement in an axial direction.

23. The motor vehicle of claim 21 in which said cylinder housing (59) is displaceable in an air axial direction relative to the cylinder core (61).

24. The motor vehicle of claim 21 in which said cylinder housing (59) has a recess (66) for interactive reception of a cylinder fin (65) on the cylinder core (61).

25. The motor vehicle of claim 21 in which said locking member (68) is coupled with a rotatable cylinder core (61) such that the locking member (68) is displaced in an axial direction in response to rotatable movement of the cylinder core (61).

26. The motor vehicle of claim 19 in which said locking bolt (68) interacts with the mounting arrangement (21).

27. The motor vehicle of claim 19 in which said mounting arrangement (21) is in a rear seatback (13) of the vehicle.

28. The motor vehicle of claim 27 in which said mounting arrangement (21) forms a through-load opening in the rear seatback (13).

29. The motor vehicle of claim 19 in which said mounting arrangement (21) is disposed in a storage or trunk space of the vehicle.

30. The motor vehicle of claim 19 in which said body (34-39) has a tubular shape with covers (44, 45) on opposite ends.

31. The motor vehicle of claim 19 in which said container (22) is a ski-bag container.

32. The motor vehicle of claim 19 in which said container (22) is a trunk container.

33. The motor vehicle of claim 19 in which said locking mechanism (50, 54) comprises at least one movable hook (53, 55) that interacts with an opening in a cover (44, 45) of the body (34-39) and which is resiliently biased into a position of engagement with the opening.

34. The motor vehicle of claim 33 in which said actuation element (46) includes an actuatable control bottom, and said hook (53, 55) is moveable to a position in which engagement of the hook (53, 55) and opening is released in response to actuation of the control bottom for allowing opening of the cover (44, 45).

35. The motor vehicle of claim 19 in said body (34, 39) has an opening (73) for receiving and holding said locking member (68).

36. A motor vehicle comprising:
at least one mounting arrangement (21),
a container (22) selectively insertable into the mounting arrangement (21) and removable from the mounting arrangement (21), said container (22) having a body (34-39) and at least one cover (44, 45) hinged on the body (34-39),
a releasable latch (42) associated with the body (34-39) that is interactable with a recess in the mounting arrangement (21) for maintaining the body (34-39) locked in the mounting arrangement (21),
a releasable locking mechanism (50, 54) for locking the cover (44, 45) in a closed position on the body,
a manual actuation element (46) coupled to the locking mechanism (50, 54) for moving the locking mechanism (50, 54) to a released position for releasing the cover (44, 45),
a locking bolt (79) supported in said mounting arrangement (21) for longitudinal displaceable movement to a position projecting from the mounting arrangement (21) and engaging in an opening (81) in the body, and
a manually actuatable lock (74) coupled with the locking bolt (79) and contained in the mounting arrangement (21) for moving the lock bolt (79).

37. The motor vehicle of claim 36 in which said lock (74) is a cylinder lock having a cylinder housing (75) in which a cylinder core (76) is rotatably mounted.

38. The motor vehicle of claim 37 in which said locking member (79) is coupled to the cylinder core (76) such that the locking bolt (79) is displaced in response to the axial direction in response to rotation of said cylinder core (76).

39. The motor vehicle of claim 37 in which said mounting arrangement (21) is in a rear seatback (13) of the vehicle.

40. The motor vehicle of claim 39 in which said mounting arrangement (21) forms a through-load opening in the rear seatback (13).

41. The motor vehicle of claim 36 in which said mounting arrangement (21) is disposed in a storage or trunk space of the vehicle.

42. The motor vehicle of claim 36 in which said body (34-39) has a tubular shape with covers (44, 45) on opposite ends.

43. The motor vehicle of claim 36 in which said container (22) is a ski-bag container.

44. The motor vehicle of claim 36 in which said container (22) is a trunk container.

45. The motor vehicle of claim 36 in which said locking mechanism (50, 54) comprises at least one movable hook (53, 55) that interacts with an opening in a cover (44, 45) of the body (34-39) and which is resiliently biased into a position of engagement with the opening.

46. The motor vehicle of claim 45 in which said actuation element (46) includes an actuatable control bottom, and said hook (53, 55) is moveable to position in which engagement of the hook (53, 55) and opening is released in response to actuation of the control bottom for allowing opening of the cover (44, 45).
